(19) United States
(12) Patent Application Publication
(10) Pub. No.: US 2023/0135279 A1
(43) Pub. Date: May 4, 2023

(54) CABLE-TO-CABLE CONNECTOR SYSTEMS

(71) Applicant: ITT Cannon Electronics Shenzhen Co Ltd, Shenzhen (CN)

(72) Inventors: Shiyong WANG, Shenzhen (CN); Zhigang WANG, Shenzhen (CN)

(73) Assignee: ITT Cannon Electronics Shenzhen Co Ltd, Shenzhen (CN)

(21) Appl. No.: 17/964,111

(22) Filed: Oct. 12, 2022

Related U.S. Application Data
(60) Provisional application No. 63/274,252, filed on Nov. 1, 2021.

(51) Int. Cl. H01R 13/533; H01R 13/52

(52) U.S. Cl. CPC H01R 13/533; H01R 13/5216

(57) ABSTRACT

A high-performance, cost- effective cable-to-cable connector assembly is described for use in harsh environment applications, where reliable signal circuits are critical to operating performance. With thermoplastic housings and elastic seals, the connectors allow use over a wide operating temperature range and enhanced sealing performance to withstand conditions of extreme temperature and moisture for demanding interconnect architectures.

### CROSS REFERENCE TO RELATED APPLICATIONS

This application claims the benefit of U.S. Provisional Patent Application Ser. No. 63/274,252 filed on Nov. 1, 2021. The disclosures of the above application are hereby incorporated by reference for all purposes.

### BACKGROUND

Unless otherwise indicated herein, the materials described in this section are not prior art to the claims in this application and are not admitted as prior art by inclusion in this section.

Connectors are electro-mechanical components that provide for exchange or power and/or communication signals between distinct electrical devices and systems. A typical connector system includes a plug and a receptacle, which fit together mechanically and provides one or more electrical connections. The mechanical portion may include various forms of coupling such as threaded coupling, click-on coupling, pressure-fit coupling, and similar ones. Depending on a purpose and functionality of a connector system, various materials such as plastic, metal, ceramic, etc. may be used. Connectors may include additional functionalities such as environmental protection, heat resistance, electromagnetic shielding, and so on. Some connector systems are standardized, where size, dimension, signal levels, or even materials are defined by an industry or government standard. Other connectors systems may be proprietary.

### SUMMARY

The present disclosure generally describes cable-to-cable connector assemblies with various connections, shapes, and protective features.

According to some examples, a cable-to-cable connector assembly may include a plug assembly, which includes a first housing, an inner surface of the first housing defining a longitudinal plug cavity; one or more sockets terminating one or more wires within the longitudinal plug cavity; a plug end seal at least partially inserted to a first end of the longitudinal plug cavity, where the one or more wires pass through the plug end seal; a secondary plug lock at least partially inserted into a second end of the longitudinal plug cavity; an interface gasket at least partially inserted into the second end of the longitudinal plug cavity; and an integrated latch on an outside surface of the first housing. The connector assembly may also include a receptacle assembly, which includes a second housing, an inner surface of the second housing defining a longitudinal receptacle cavity; one or more pins terminating one or more other wires within the longitudinal receptacle cavity; a receptacle end seal at least partially inserted to a first end of the longitudinal receptacle cavity, where the other one or more wires pass through the receptacle end seal; and a secondary receptacle lock at least partially inserted into the second end of the longitudinal receptacle cavity.

According to other examples, a connector assembly may include a plug assembly, which includes a housing, an inner surface of the housing defining a longitudinal cavity; one or more sockets terminating one or more wires within the longitudinal cavity; an end seal at least partially inserted to a first end of the longitudinal cavity, where the one or more wires pass through the end seal; a secondary lock at least partially inserted into a second end of the longitudinal cavity; an integrated latch on an outside surface of the housing; an interface gasket at least partially inserted into the second end of the longitudinal cavity; and an end cap to fit over the housing at the first end of the longitudinal cavity through a snap-on mechanism, where the end cap is configured to cover the end seal and the one or more wires also pass through the end cap.

According to further examples, a connector assembly may include a receptacle assembly, which includes a housing, an inner surface of the housing defining a longitudinal cavity; one or more pins terminating one or more wires within the longitudinal cavity; an end seal at least partially inserted to a first end of the longitudinal cavity, where the one or more wires pass through the end seal; a secondary lock at least partially inserted into the second end of the longitudinal cavity; and an end cap to fit over the housing at the first end of the longitudinal cavity through a snap-on mechanism, where the end cap is configured to cover the end seal and the one or more wires also pass through the end cap.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates exploded assembly views of a plug-receptacle pair of an example connector assembly;

FIG. 2 illustrates front views of example configurations of various connectors;

FIG. 3 illustrates various views of a two-pin/socket configuration of an example plug- receptacle pair;

FIG. 4 illustrates various views of a three-pin/socket configuration of an example plug- receptacle pair;

FIG. 5 illustrates various views of a four-pin/socket configuration of an example plug- receptacle pair;

FIG. 6 illustrates various views of a six-pin/socket configuration of an example plug- receptacle pair;

FIG. 7 illustrates various example back shell configurations; and

FIG. 8 illustrates example mounting clip configurations, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods of manufacture, apparatus, systems and/or devices associated with cable-to-cable connector assemblies with various connections, shapes, and protective features.

Briefly stated, a high-performance, cost- effective cable-to-cable connector assembly is described for use in harsh environment applications, where reliable signal circuits are critical to operating performance. With thermoplastic housings and elastic seals, the connectors allow use over a wide operating temperature range and enhanced sealing performance to withstand conditions of extreme temperature and moisture for demanding interconnect architectures.

Disclosed herein are connector assemblies with ruggedized housing, internal seals, primary and secondary locks with multiple pin configurations. Connectors may be color coded and/or keyed for easy interconnection with matching configurations. Different back shell configurations may allow various applications in demanding environments such as automotive harnessing, lighting systems, agricultural or industrial applications, etc.

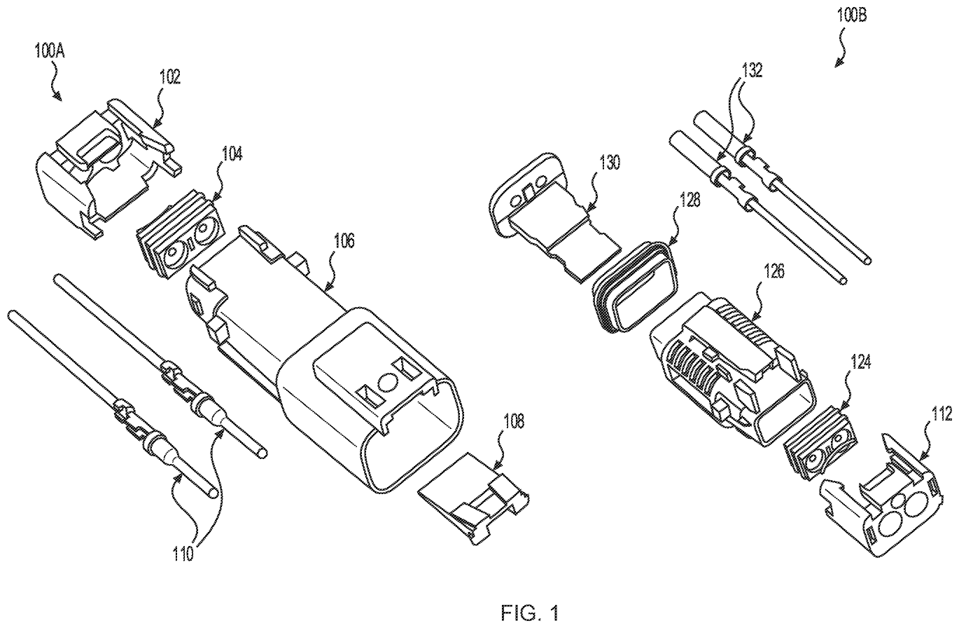

FIG. 1 illustrates exploded assembly views of a plug-receptacle pair of an example connector assembly, arranged in accordance with at least some embodiments described herein.

Diagram 100A in FIG. 1 includes components of a receptacle with receptacle housing 106, end cap 102, end seal 104, secondary lock 108, and pin contacts 110. Diagram 100B in FIG. 1 includes components of a plug with plug housing 126, end cap 112, end seal 124, interface gasket 128, secondary lock 130, and socket contacts 132.

With the proliferation of electronic devices and peripherals, the variety and number of interconnectivity mechanisms including different power and communication cabling in residential, industrial, automotive, and other industries has increased dramatically. While wireless connectivity is increasingly popular, some environments (e.g., higher electromagnetic noise environments, secure communication needs, etc.) still require wired connections. Especially in demanding environments (e.g., military use, mobile environments, hazardous environments, etc.), connectors need to be robust and resistant to environmental hazards for reliable performance.

Example embodiments provide high-performance, cost- effective cable-to-cable connector assemblies with ruggedized housing, internal seals, primary and secondary locks with multiple pin configurations. An example plug may feature an integral coupling latch that provides tactile and audible feedback during coupling. The rugged receptacle may be an inline for cable-to-cable applications and may be supplied with an integral “V”-groove to accept mounting clips and brackets. A secondary lock structure may be adopted in some examples for both of pin and socket contacts fixing in the connector housings, ease of assembly and disassembly without a demand for special tools. Moreover, various mechanical codings (keys) and color coding may be used to achieve prevention of mis-operations.

The outer shells (receptacle housing 106 and plug housing 126) may be rectangular, square, triangular, circular, oval, or other shapes based on the configuration (e.g., number of connections). The integral coupling latch may provide primary lock mechanism preventing the receptacle and the plug from becoming loose. The secondary locks ensure the terminals are fixed in their end positions and may also provide strain relief. In an assembled mode, a cable with multiple wires or individual cables with single wires may penetrate through the end caps (102, 112) and the end seals (104, 124), and terminate in the respective pin or socket contacts. Coupling between the plug and receptacle of the connector assembly is, as discussed above, through an integral latch, but other compatible mechanisms may also be used.

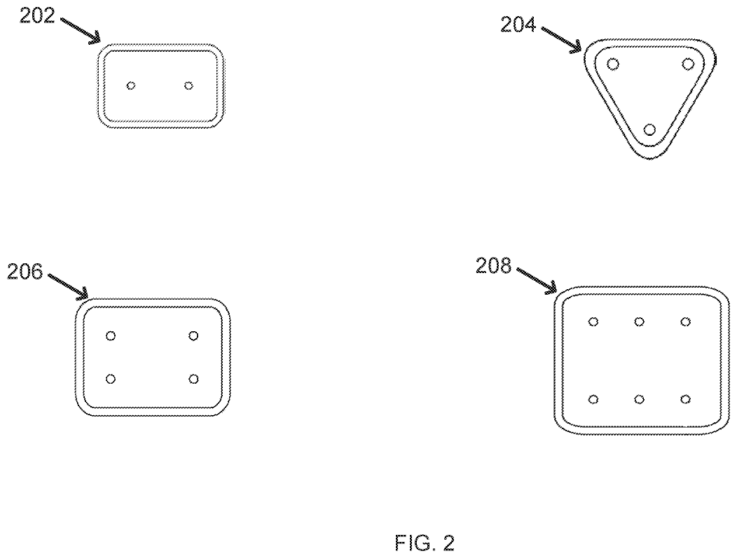

FIG. 2 illustrates front views of example configurations of various connectors, arranged in accordance with at least some embodiments described herein.

The examples configurations in FIG. 2 include configuration 202 with two pins/sockets, configuration 204 with three pins/sockets, configuration 206 with four pins/sockets, and configuration 208 with six pins/sockets. Of course, other configurations with higher numbers of pins/sockets may also be implemented. For example, ten, twelve, or sixteen pin connectors are commonly used. A cross-sectional shape of the connector assembly may be determined based on the number of pins/sockets. For example, configurations 202, 206, and 208 with even numbers of pins/sockets are shown as having substantially rectangular shape, while the connector assembly with three pins/sockets has a substantially triangular shape. Other cross-sectional shapes may also be implemented.

The configurations shown in FIG. 2 are for illustration purposes only and are not intended as limitations on embodiments. A number of pins/sockets may be any practical number depending on the size and functionality of the connector assemblies. Another consideration in selecting a number of the pins/sockets may be dimension and clearance requirements imposed by practical design considerations and/or standards. Additional features of the connector assembly such as shielding, heat resistance, insulation may also affect the number of pins/sockets to be combined by imposing limitations on the connector assembly dimensions and material types.

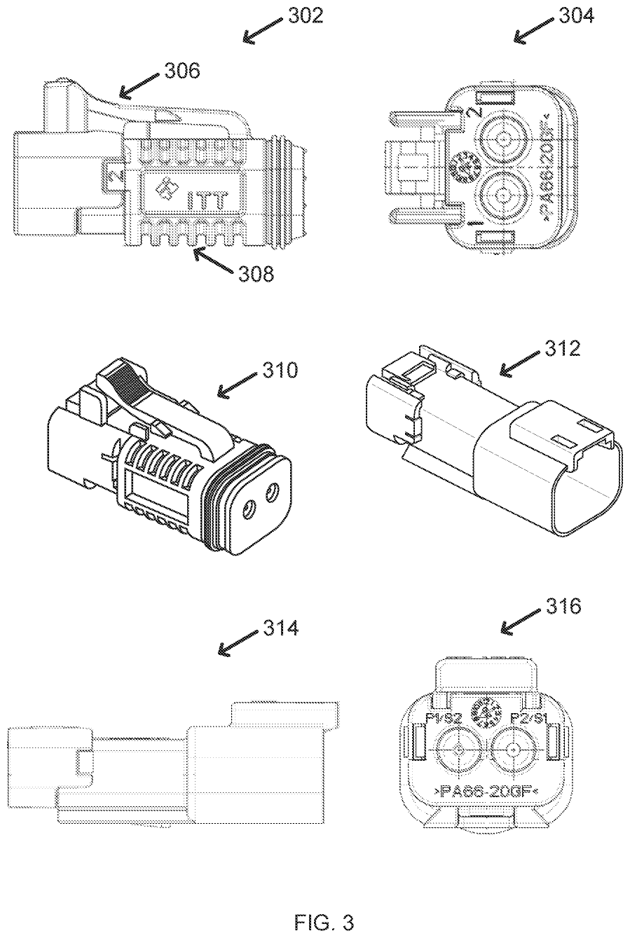

FIG. 3 illustrates various views of a two-pin/socket configuration of an example plug-receptacle pair, arranged in accordance with at least some embodiments described herein.

Diagram 300 shows a side view of a two-socket plug 302 with its integral latch 306 and ruggedized outside surface (ribs) 308, front view 304 of the same plug, and a perspective view 310 of the same plug with its end seal and secondary lock in place. The diagram also shows a perspective view 312 of a matching three-pin receptacle with its end cap in place, side view 314 of the same receptacle, and front view 316 of the same receptacle.

According to some examples, the secondary locks may include a mechanical key and/or a color coding to prevent mismatches and for easier combination of matching receptacles and plugs. A high number of different configurations of the connector assemblies may be possible with different numbers of pins/sockets, regular or reverse pin/socket configurations, including or lacking end caps and/or secondary locks in one or both of the receptacle and plug. Thus, mechanical keying and/or color coding may help identify matching pairs during assembly and during operation (e.g., for maintenance, replacement, etc.).

The ruggedized outside surface 308 of the plug may allow easier manual assembly and also assist with sealing (by pressing against an internal surface of the receptacle). The end seals and the end caps may provide further sealing against environmental hazards such as water or gases, as well as provide further mechanical robustness (i.e., act as strain reliefs). The integral latch 306, as mentioned previously, may prevent the plug and the receptacle from separating while providing tactile feedback of correct assembly.

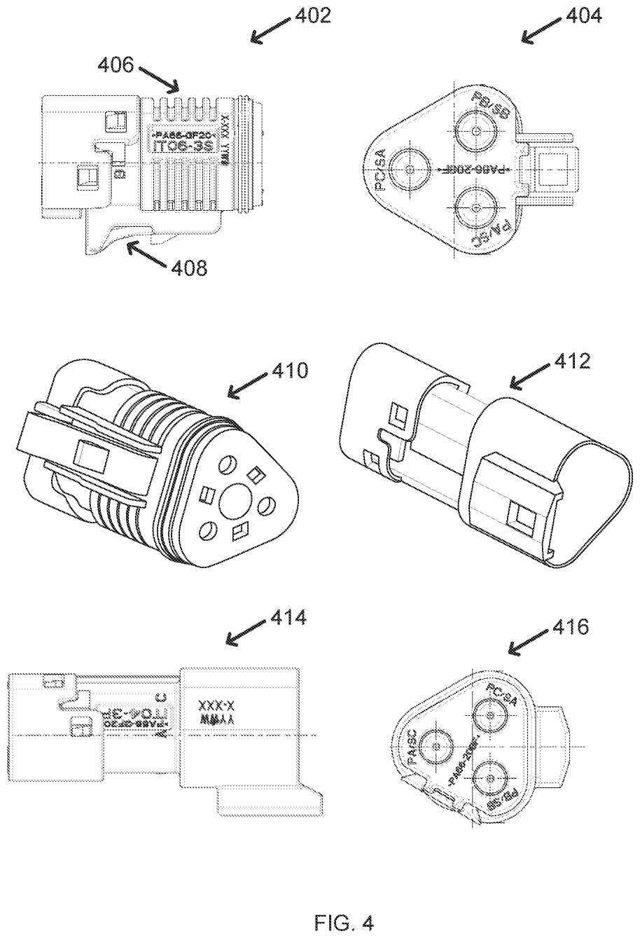

FIG. 4 illustrates various views of a three-pin configuration of an example plug- receptacle pair, arranged in accordance with at least some embodiments described herein.

Diagram 400 shows a side view of a three-socket plug 402 with its integral latch 408 and ruggedized outside surface (ribs) 406, front view 404 of the same plug, and a perspective view 410 of the same plug with its end seal and secondary lock in place. The diagram also shows a perspective view 412 of a matching three-pin receptacle with its end cap in place, side view 414 of the same receptacle, and front view 416 of the same receptacle.

The optional end caps may be implemented as snap-on components providing strain relief and/or further sealing and durability. While the three-pin/socket connector assembly is shown with a substantially triangular cross-sectional shape, other cross-sectional shapes may also be adopted.

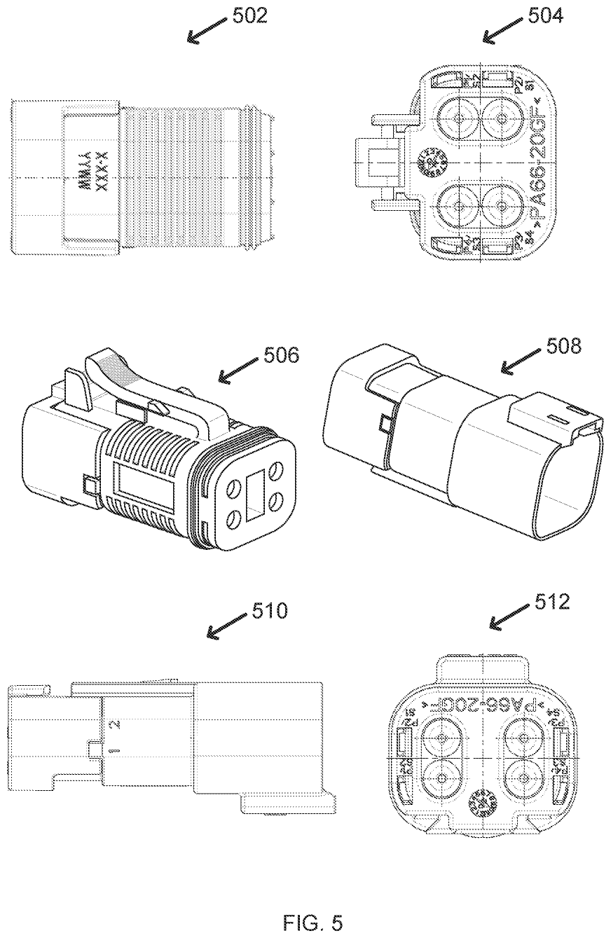

FIG. 5 illustrates various views of a four-pin/socket configuration of an example plug-receptacle pair, arranged in accordance with at least some embodiments described herein.

Diagram 500 shows a side view of a four-socket plug 502, front view 504 of the same plug, and a perspective view 506 of the same plug with its end seal and secondary lock in place. The diagram also shows a perspective view 508 of a matching four-pin receptacle with its end cap in place, side view 510 of the same receptacle, and front view 512 of the same receptacle.

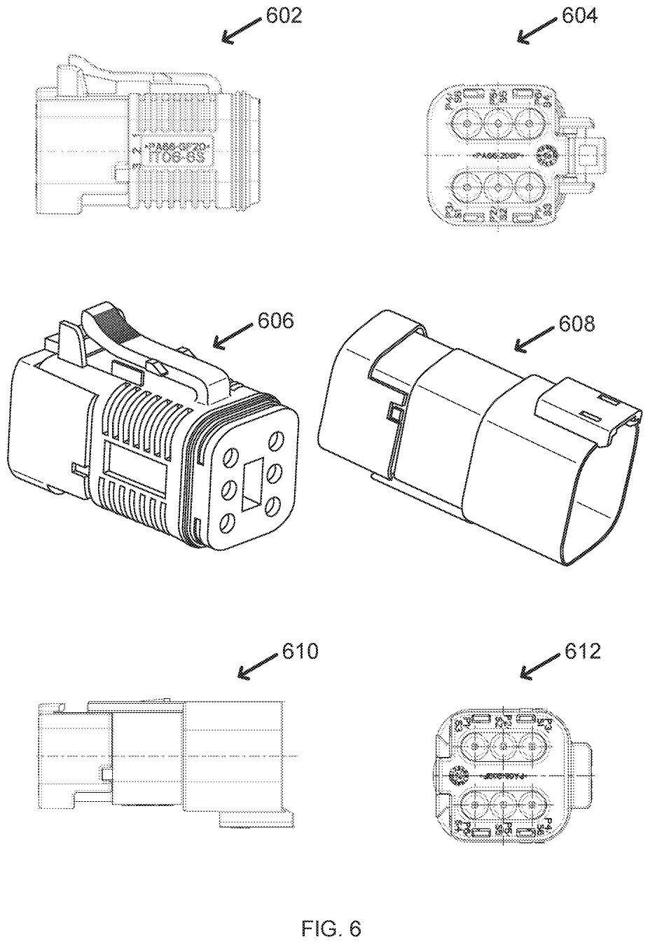

FIG. 6 illustrates various views of a six-pin/socket configuration of an example plug-receptacle pair, arranged in accordance with at least some embodiments described herein.

Diagram 600 shows a side view of a six-socket plug 602, front view 604 of the same plug, and a perspective view 606 of the same plug with its end seal and secondary lock in place. The diagram also shows a perspective view 608 of a matching six-pin receptacle with its end cap in place, side view 610 of the same receptacle, and front view 612 of the same receptacle.

As mentioned previously, example connector assemblies may be implemented as interconnect solutions for heavy equipment, agricultural, automotive, industrial, off-road, alternative energy, and other demanding interconnect architectures. Some of the example implementations may include, but are not limited to, engine and transmission harnessing, lighting systems, controllers, signal interfaces, cabin and accessory harnessing, seat and window controls, under hood electronics, displays, sensors, etc.

Some example performance parameters of example connectors assemblies may include, but are not limited to, contact current ratings up to 13 A, operating voltage ratings up to 250 V, operating temperature ratings between about −55° C. and about 125° C., IP68 and IP6K9K environmental sealing, up to 200 cycle stamp contact rating for durability, up to 1500 V dielectric voltage rating, up to 50 g physical shock rating, etc. Example diameters of the wires may range from 20AWG to 14 AWG in some implementations.

The plug and receptacle housings may be made from thermoplastic materials such as glass filled polyamides. Seals and interface gaskets may be made from elastic materials such as silicone rubber. Secondary locks may be made also from thermoplastic materials such as glass filled polybutylene terephthalate (PBT). Pin and socket contacts may be made from copper alloy or stainless steel and may be nickel, tin, silver, or gold plated. The plug and receptacle connector assemblies may be further ruggedized (resistance against vibration, wear and tear), environmentally protected (heat, dust, humidity, etc.), and/or shielded against electromagnetic and/or electrostatic disturbances.

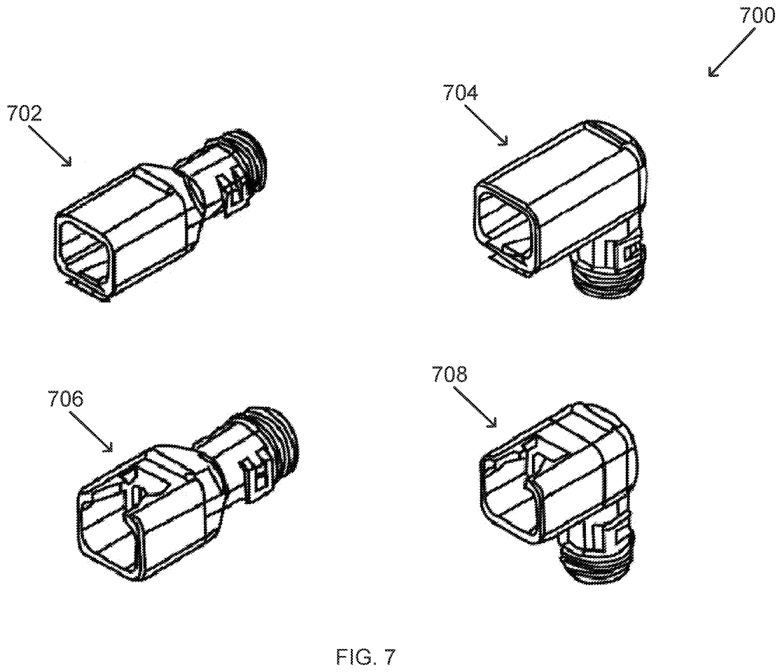

FIG. 7 illustrates various example back shell configurations, arranged in accordance with at least some embodiments described herein.

Diagram 700 shows a 180° receptacle back shell, a 90° receptacle back shell, a 180° plug back shell, and a 90° plug back shell. A back shell is a mechanical device threaded into the rear of an electrical connector. Example back shells include strain reliefs, cable clamps and adaptors. In addition to providing a secure transition from connector assembly housing to another structure such as tubing, back shells may also provide additional functionality. For example, in commercial aircraft, screened back shells may help shield or screen harnesses in power and communications systems from electromagnetic interference (EMI) and radio- frequency interference (RFI) noise. In aircraft radar systems, back shells may help protect systems by providing grounding paths in the event of lightning strikes. Strain relief is also provided by the back shells to help protect connections from loosening under extreme vibration. While 90° and 180° example back shells are shown in the diagram, other angles may be implemented as well.

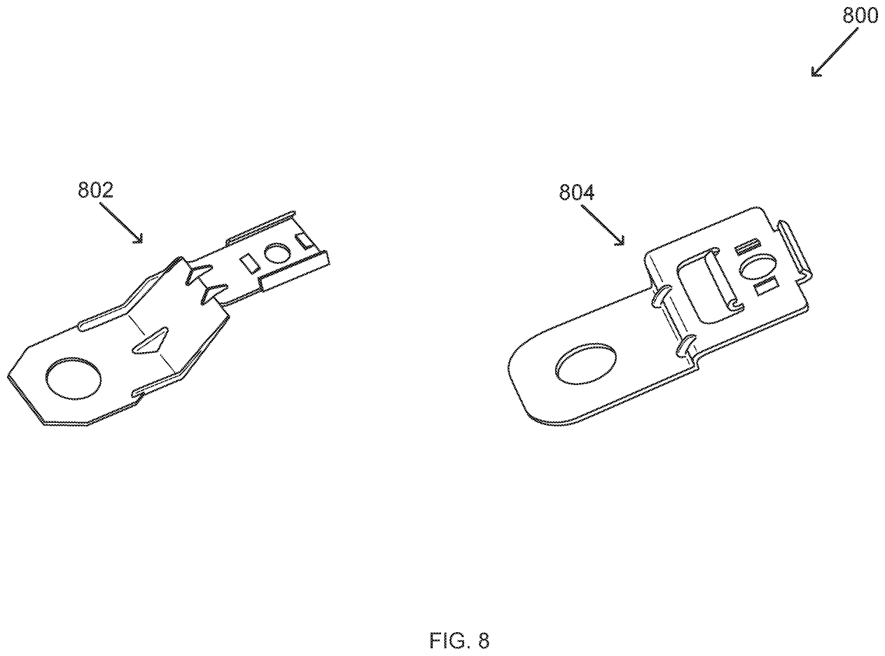

FIG. 8 illustrates example mounting clip configurations, arranged in accordance with at least some embodiments described herein.

Diagram 800 shows an example straight mounting direction mounting clip 802 and a side mounting direction mounting clip 804. Mounting clips are used to secure the connector assembly and/or a harness. Mounting clips may be made from durable material such as steel with zinc plating or stainless steel and their size and screw hole diameter may be adjustable for implementation-specific needs.

The benefits of the presently disclosed connector assembly devices are numerous. For example, the connector assemblies disclosed herein may allow robust and reliable multiple connections between different devices in demanding environments. The modular configurations may allow in the field or at manufacturing selection of different connector types and/or pin- socket numbers. Integral latching mechanisms may allow simple removal of plugs and receptacles while preventing accidental removal or loosening. Secondary locks may provide further robustness and strain relief, while color coding may allow easy identification of matching configurations and prevent mis-connections. Such features not only enhance practical aspects of example connector assemblies but may also provide enhanced protection even in harsh environments.

According to some examples, a cable-to-cable connector assembly may include a plug assembly, which includes a first housing, an inner surface of the first housing defining a longitudinal plug cavity; one or more sockets terminating one or more wires within the longitudinal plug cavity; a plug end seal at least partially inserted to a first end of the longitudinal plug cavity, where the one or more wires pass through the plug end seal; a secondary plug lock at least partially inserted into a second end of the longitudinal plug cavity; an interface gasket at least partially inserted into the second end of the longitudinal plug cavity; and an integrated latch on an outside surface of the first housing. The connector assembly may also include a receptacle assembly, which includes a second housing, an inner surface of the second housing defining a longitudinal receptacle cavity; one or more pins terminating one or more other wires within the longitudinal receptacle cavity; a receptacle end seal at least partially inserted to a first end of the longitudinal receptacle cavity, where the other one or more wires pass through the receptacle end seal; and a secondary receptacle lock at least partially inserted into the second end of the longitudinal receptacle cavity.

According to other examples, the connector assembly may further include a plug end cap to fit over the first housing at the first end of the longitudinal plug cavity through a snap- on mechanism, where the plug end cap is configured to cover the plug end seal and the one or more wires also pass through the plug end cap. The connector assembly may also include a receptacle end cap to fit over the second housing at the first end of the longitudinal receptacle cavity through a snap-on mechanism, where the receptacle end cap is configured to cover the receptacle end seal and the other one or more wires also pass through the receptacle end cap. The first housing and the second housing may have a cross-sectional shape defined based on a number of pins and sockets, respectively, in the plug assembly and the receptacle assembly. The cross-sectional shape may be substantially triangular for three pins or sockets and substantially rectangular for two, four, or six pins or sockets.

According to further examples, the secondary plug lock and the secondary receptacle lock may include one or more of a mechanical key or a color code to identify a configuration of the plug assembly and the receptacle assembly, respectively. One or more of the plug end seal, the receptacle end seal, or the interface gasket may include a color code to identify a configuration of the plug assembly and the receptacle assembly, respectively. A material and a shape of one or more of the first housing, the second housing, the plug end seal, the receptacle end seal, or the interface gasket may be selected such that the plug assembly and/or the receptacle assembly are ruggedized, environmentally sealed, or electromagnetically shielded. The first housing and the second housing may be made from thermoplastic material, and the plug end seal, the receptacle end seal, and the interface gasket may be made from elastic material. The connector assembly may also include a back shell coupled to the first end of the longitudinal plug cavity or the first end of the longitudinal receptacle cavity to provide secure transition to a cable containing the one or more wires or the other one or more wires. The back shell may be a 180° back shell or a 90° back shell.

According to other examples, a connector assembly may include a plug assembly, which includes a housing, an inner surface of the housing defining a longitudinal cavity; one or more sockets terminating one or more wires within the longitudinal cavity; an end seal at least partially inserted to a first end of the longitudinal cavity, where the one or more wires pass through the end seal; a secondary lock at least partially inserted into a second end of the longitudinal cavity; an integrated latch on an outside surface of the housing; an interface gasket at least partially inserted into the second end of the longitudinal cavity; and an end cap to fit over the housing at the first end of the longitudinal cavity through a snap-on mechanism, where the end cap is configured to cover the end seal and the one or more wires also pass through the end cap.

According to some examples, the housing may have a cross-sectional shape defined based on a number of the sockets in the plug assembly. The cross-sectional shape may be substantially triangular for three sockets and substantially rectangular for two, four, or six sockets. The secondary lock may include one or more of a mechanical key or a color code to identify a configuration of the plug assembly. The end seal may include a color code to identify a configuration of the plug assembly. A material and a shape of one or more of the housing, the end seal, or the end cap may be selected such that the plug assembly is ruggedized, environmentally sealed, or electromagnetically shielded. The housing and the end cap may be made from thermoplastic material, and the end seal and the interface gasket may be made from elastic material. The connector assembly may further include a back shell coupled to the first end of the longitudinal cavity to provide secure transition to a cable containing the one or more wires, where the back shell is a 180° back shell or a 90° back shell.

According to further examples, a connector assembly may include a receptacle assembly, which includes a housing, an inner surface of the housing defining a longitudinal cavity; one or more pins terminating one or more wires within the longitudinal cavity; an end seal at least partially inserted to a first end of the longitudinal cavity, where the one or more wires pass through the end seal; a secondary lock at least partially inserted into the second end of the longitudinal cavity; and an end cap to fit over the housing at the first end of the longitudinal cavity through a snap-on mechanism, where the end cap is configured to cover the end seal and the one or more wires also pass through the end cap.

According to other examples, the housing may have a cross-sectional shape defined based on a number of the pins in the receptacle assembly. The cross-sectional shape may be substantially triangular for three pins and substantially rectangular for two, four, or six pins. The secondary lock may include one or more of a mechanical key or a color code to identify a configuration of the receptacle assembly. The end seal may include a color code to identify a configuration of the receptacle assembly. A material and a shape of one or more of the housing, the end seal, the interface gasket, or the end cap may be selected such that the receptacle assembly is ruggedized, environmentally sealed, or electromagnetically shielded. The housing and the end cap may be made from thermoplastic material, and the end seal may be made from elastic material. The connector assembly may further include a back shell coupled to the first end of the longitudinal cavity to provide secure transition to a cable containing the one or more wires, wherein the back shell is a 180° back shell or a 90° back shell.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

The herein described subject matter sometimes illustrates different components contained within, or connected with, different other components. Such depicted architectures are merely examples, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

What is claimed is:

1. A cable-to-cable connector assembly comprising:
a plug assembly comprising:
a first housing, an inner surface of the first housing defining a longitudinal plug cavity;
one or more sockets terminating one or more wires within the longitudinal plug cavity;
a plug end seal at least partially inserted to a first end of the longitudinal plug cavity, wherein the one or more wires pass through the plug end seal;
a secondary plug lock at least partially inserted into a second end of the longitudinal plug cavity;
an interface gasket at least partially inserted into the second end of the longitudinal plug cavity; and
an integrated latch on an outside surface of the first housing; and
a receptacle assembly comprising:
a second housing, an inner surface of the second housing defining a longitudinal receptacle cavity;
one or more pins terminating one or more other wires within the longitudinal receptacle cavity;
a receptacle end seal at least partially inserted to a first end of the longitudinal receptacle cavity, wherein the other one or more wires pass through the receptacle end seal; and
a secondary receptacle lock at least partially inserted into a second end of the longitudinal receptacle cavity.

2. The connector assembly of claim 1, further comprising:
a plug end cap to fit over the first housing at the first end of the longitudinal plug cavity through a snap-on mechanism, wherein the plug end cap is configured to cover the plug end seal and the one or more wires also pass through the plug end cap.

3. The connector assembly of claim 1, further comprising:
a receptacle end cap to fit over the second housing at the first end of the longitudinal receptacle cavity through a snap-on mechanism, wherein the receptacle end cap is configured to cover the receptacle end seal and the other one or more wires also pass through the receptacle end cap.

4. The connector assembly of claim 1, wherein the first housing and the second housing have a cross-sectional shape defined based on a number of pins and sockets, respectively, in the plug assembly and the receptacle assembly.

5. The connector assembly of claim 4, wherein the cross-sectional shape is substantially triangular for three pins or sockets and substantially rectangular for two, four, or six pins or sockets.

6. The connector assembly of claim 1, wherein
the secondary plug lock and the secondary receptacle lock include one or more of a mechanical key or a color code to identify a configuration of the plug assembly and the receptacle assembly, respectively;
one or more of the plug end seal, the receptacle end seal, or the interface gasket include a color code to identify a configuration of the plug assembly and the receptacle assembly, respectively; or
a material and a shape of one or more of the first housing, the second housing, the plug end seal, the receptacle end seal, or the interface gasket are selected such that the plug assembly and/or the receptacle assembly are ruggedized, environmentally sealed, or electromagnetically shielded.

7. The connector assembly of claim 1, wherein
the first housing and the second housing are made from thermoplastic material, and
the plug end seal, the receptacle end seal, and the interface gasket are made from elastic material.

8. The connector assembly of claim 1, further comprising:
a back shell coupled to the first end of the longitudinal plug cavity or the first end of the longitudinal receptacle cavity to provide secure transition to a cable containing the one or more wires or the other one or more wires, wherein the back shell is a 180° back shell or a 90° back shell.

9. A connector assembly comprising:
a plug assembly comprising:
a housing, an inner surface of the housing defining a longitudinal cavity;
one or more sockets terminating one or more wires within the longitudinal cavity;
an end seal at least partially inserted to a first end of the longitudinal cavity, wherein the one or more wires pass through the end seal;
a secondary lock at least partially inserted into a second end of the longitudinal cavity;
an integrated latch on an outside surface of the housing;
an interface gasket at least partially inserted into the second end of the longitudinal cavity; and
an end cap to fit over the housing at the first end of the longitudinal cavity through a snap-on mechanism, wherein the end cap is configured to cover the end seal and the one or more wires also pass through the end cap.

10. The connector assembly of claim 9, wherein the housing has a cross-sectional shape defined based on a number of the sockets in the plug assembly.

11. The connector assembly of claim 10, wherein the cross-sectional shape is substantially triangular for three sockets and substantially rectangular for two, four, or six sockets.

12. The connector assembly of claim 9, wherein
the secondary lock includes one or more of a mechanical key or a color code to identify a configuration of the plug assembly;
the end seal includes a color code to identify a configuration of the plug assembly; or
a material and a shape of one or more of the housing, the end seal, or the end cap are selected such that the plug assembly is ruggedized, environmentally sealed, or electromagnetically shielded.

13. The connector assembly of claim 9, wherein the housing and the end cap are made from thermoplastic material, and the end seal and the interface gasket are made from elastic material.

14. The connector assembly of claim 9, further comprising:
a back shell coupled to the first end of the longitudinal cavity to provide secure transition to a cable containing the one or more wires, wherein the back shell is a 180° back shell or a 90° back shell.

15. A connector assembly comprising:
a receptacle assembly comprising:
a housing, an inner surface of the housing defining a longitudinal cavity;
one or more pins terminating one or more wires within the longitudinal cavity;
an end seal at least partially inserted to a first end of the longitudinal cavity, wherein the one or more wires pass through the end seal;
a secondary lock at least partially inserted into a second end of the longitudinal cavity; and
an end cap to fit over the housing at the first end of the longitudinal cavity through a snap-on mechanism, wherein the end cap is configured to cover the end seal and the one or more wires also pass through the end cap.

16. The connector assembly of claim 15, wherein the housing has a cross-sectional shape defined based on a number of the pins in the receptacle assembly.

17. The connector assembly of claim 16, wherein the cross-sectional shape is substantially triangular for three pins and substantially rectangular for two, four, or six pins.

18. The connector assembly of claim 15, wherein the secondary lock includes one or more of a mechanical key or a color code to identify a configuration of the receptacle assembly.

19. The connector assembly of claim 15, wherein
the end seal includes a color code to identify a configuration of the receptacle assembly;
a material and a shape of one or more of the housing, the end seal, the interface gasket, or the end cap are selected such that the receptacle assembly is ruggedized, environmentally sealed, or electromagnetically shielded; or
the housing and the end cap are made from thermoplastic material, and the end seal is made from elastic material.

20. The connector assembly of claim 15, further comprising:
a back shell coupled to the first end of the longitudinal cavity to provide secure transition to a cable containing the one or more wires, wherein the back shell is a 180° back shell or a 90° back shell.
